(19) United States
(12) Patent Application Publication
(10) Pub. No.: US 2011/0231222 A1
(43) Pub. Date: Sep. 22, 2011

(54) Method and System for Enhanced Transaction Management

(75) Inventors: Pawan Kumar Sharma, New York, NY (US); Christopher Thomas Lukic, New York, NY (US); Amar Shibli, Hanover, NH (US); Tanvi Rishin Shah, Jersey City, NJ (US)

(73) Assignee: Bank of America Corporation, Charlotte, NC (US)

(21) Appl. No.: 12/727,538

(22) Filed: Mar. 19, 2010

(51) Int. Cl. G06Q 10/00; G06Q 40/00

(52) U.S. Cl. 705/7.29; 705/35

(57) ABSTRACT

An integrated transaction module associated with an entity allows for consolidating and using information related to management of transactions. The integrated transaction system incorporates a transaction viewer for displaying information such as the companies involved in the transaction, level of interest shown by potential clients in hiring the entity to manage the transaction, whether or not the companies involved in the transaction present any conflict-of-interest for the transaction management company, and any attachments that may be relevant to the transaction. In addition, the integrated transaction system incorporates a transaction team conflicts checker to determine whether or not any of the team members involved in the transaction pose a conflict-of-interest and a best client analyzer for determining which of several potential clients offer the most benefits to the transaction management organization.

### TECHNICAL FIELD

Aspects of the invention generally relate to a method and system for enhanced transaction management. In particular, various aspects of the invention include a framework for selecting potential clients involved in transactions based on an analysis of various business factors.

### BACKGROUND

Organizations generally perform conflict checks to ensure that accepting work from a particular client does not result in a conflict-of-interest with other clients. A conflict-of-interest may exist for a number of reasons. For instance, in managing a transaction between a company seeking to acquire another, an organization may face a conflict-of-interest if both the buyer and seller are seeking expertise from the organization. In this case, the buyer will have reason to believe that his best interests are not being served (e.g., obtaining the cheapest price, etc.) if the seller is also a client of the same organization, and vice versa. If work resulting in a conflict-of-interest is pursued, the organization may face severe consequences, including but not limited to loss of reputation, legal action by one of the parties involved, and/or governmental sanctions.

Given the importance of avoiding conflict-of-interest scenarios, an organization may have a conflicts group dedicated to considering all available information before approving new work for the company. The conflicts group generally uses a database storing previous clients and associated interactions resulting from the work done with these clients to determine whether pending workflow requests should be granted.

These database systems are generally standalone systems that do not interface with other systems that are a part of the entire transaction making process (e.g., revenue tracking systems, stock trading restriction systems, etc.). Prior art database systems usually list records of clients previously associated with the organization. To come to a conclusion about whether or not a pending workflow request represents a conflict-of-interest, a member of the conflicts group must meticulously search record by record to determine if any of the records contain information adverse to granting the workflow request. Searching through these standalone storage systems to cull information relevant to a particular client/business opportunity is time consuming and error-prone. This inefficiency may result in loss of business when decisions about clients must be made quickly and accurately.

In addition, previous/current interactions of an organization with parties adverse to a new client opportunity are only one reason for denying/rejecting a workflow request. Other reasons include a lack of adequate revenue represented by the new opportunity, current equity positions preventing the organization from moving forward, and/or strategic long-term partnerships with clients deemed more important than the new work opportunity, among other things. When multiple factors for moving forward with business opportunities are involved, as is typically the case, the conflicts group must search multiple standalone systems; for instance, they must interface with a database listing previous client interactions followed by other systems that include information about equity positions and/or revenue models for new business opportunities. Given the many databases that must be accessed and analyzed, an individual tasked with this responsibility suffers from numerous systemic problems, such as a lack of consistency between records in each of these systems (e.g., client names are not consistently referenced in all systems, updates to transaction records are not propagated to all systems, systems are not accessed sequentially to take into account information gained from previous searches, etc.).

Also, conflicts checking involves notifying appropriate personnel (e.g., senior management, etc.) about workflow requests so that decisions may be made. Conventional conflicts systems do not integrate reporting capabilities into a single platform. Once all of the analysis is complete, individuals must use a separate platform (e.g., email, interoffice memos, etc.) to report updates in the system, final decisions about workflow requests, etc., which increases the time inefficiencies that plague conventional systems/processes.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable media, and apparatuses for an integrated transaction system. Aspects may be used to check for conflicts in taking on new clients/projects, determine key team members working on a particular project, and analyze information related to potential clients to determine which one maximizes benefits, among other things.

With another aspect of the disclosure, the integrated transaction system may interface with other computing devices to ensure that references to clients, people, etc. may be consistent between all the devices and/or to ensure that updates are consistently propagated between systems.

With yet another aspect of the disclosure, an integrated reporting feature may be implemented to provide key personnel with regular reports, updates, etc.

Aspects of the disclosure may be provided in a computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and computers that may be used to implement the processes and functions of certain aspects of the disclosure.

FIG. 3 shows a sample transaction viewer screen in accordance with various aspects of the disclosure.

FIG. 4 shows an exemplary conflicts check screen in accordance with various aspects of the disclosure.

FIG. 5 shows a sample transaction team conflicts check screen in accordance with various aspects of the disclosure.

FIG. 6 shows a sample search screen in accordance with various aspects of the disclosure.

FIG. 7 shows a sample best client/financial tree screen in accordance with various aspects of the disclosure.

### DETAILED DESCRIPTION

As discussed above, there are problems associated with the way workflow processes for transactions, deals, mergers and acquisitions, etc. are managed. As discussed below, the terms transactions, deals, and mergers and acquisitions can be used interchangeably throughout the description of the invention.

In accordance with certain aspects of the disclosure, an integrated transaction (tran) system may serve as a centralized processing resource for conflicts checking, reporting, record updating, and comparing benefits of various potential clients. In this way, a streamlined approach to handling workflow requests may be implemented. For instance, the integrated processing unit may reference client names consistently in all systems, update transaction records in all relevant systems, and manage the accessing of separate systems in a predetermined sequence to take into account information gained from previous searches, among other things.

Throughout this disclosure, the term “integrated transaction system” or “integrated transaction module” may be used interchangeably to represent the computing device storing program instructions enabling enhanced transaction management functions as described herein and/or the program instructions themselves.

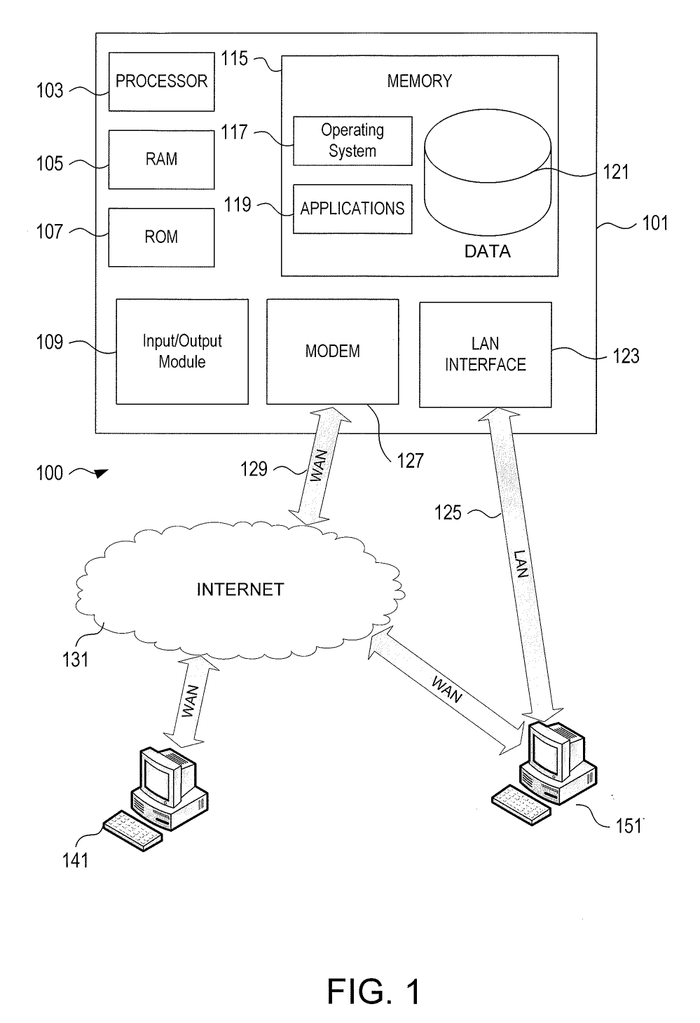

FIG. 1 illustrates a block diagram of an integrated transaction module 101 (e.g., a computing device) in a communication system 100 that may be used according to an illustrative embodiment of the disclosure. The transaction module 101 may have a processor 103 for controlling overall operation of the transaction module 101 and its associated components, including random access memory (RAM) 105, read-only memory (ROM) 107, input/output (I/O) module 109, and/or memory 115.

The I/O module 109 may include a microphone, keypad, touch screen, and/or stylus through which a user of the transaction module 101 may provide input, and may also include one or more of a speaker for providing audio output and a video display device for providing textual, audiovisual and/or graphical output. Software may be stored within the memory 115 and/or storage to provide instructions to the processor 103 for enabling the transaction module 101 to perform various functions. For example, the memory 115 may store software used by the integrated transaction module 101, such as an operating system 117, application programs 119, and an associated database 121. The processor 103 and its associated components may allow the transaction module 101 to generate reports, ensure consistency among records across multiple platforms, remove duplicate records, ensure that systems are accessed sequentially when making decisions about transactions, and manage a conflicts checking process for new business opportunities, among other things. The processor 103 may also be responsible for displaying information related to several different clients to aid in analysis of which client represents the best business prospect for an organization.

The transaction module 101 may operate in a networked environment supporting connections to one or more remote computers, such as terminals 141 and 151. The terminals 141 and 151 may be personal computers or servers that include many or all of the elements described above relative to the transaction module 101. Alternatively, terminal 141 and/or 151 may represent different systems (e.g., revenue tracking system, equity trading restriction system, etc.) that communicate with the transaction module 101. The network connections depicted in FIG. 1 include a local area network (LAN) 125 and a wide area network (WAN) 129, but may also include other networks. When used in a LAN networking environment, the transaction module 101 is connected to the LAN 125 through a network interface or adapter 123. When used in a WAN networking environment, the transaction module 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Also, an application program 119 used by the integrated transaction module 101 according to an illustrative embodiment of the disclosure may include additional computer executable instructions for invoking functionality related to conflicts checking, workflow intake management, etc.

The transaction module 101 and/or terminals 141 or 151 may also be mobile terminals including various other components, such as a battery, speaker, and antennas (not shown) without departing from this invention.

This disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc., that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

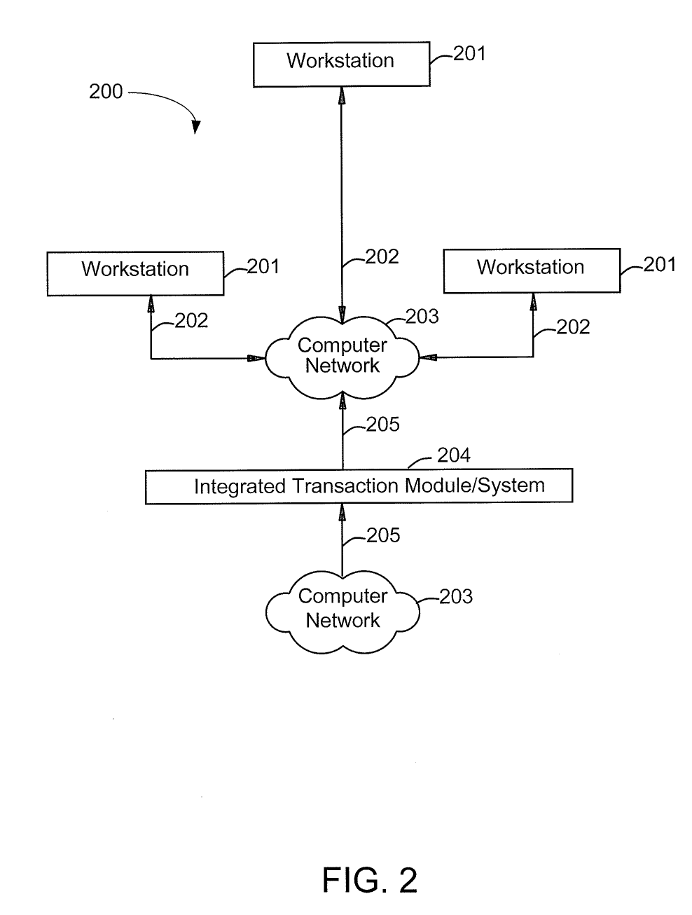

Referring to FIG. 2, an illustrative system 200 for implementing methods according to the disclosure is shown. As illustrated, the system 200 may include one or more workstations 201. The workstations 201 may be local or remote, and may be connected by one or more communications links 202 to a computer network 203 that is linked via communications links 205 to an integrated transaction module 204. In certain embodiments, the workstations 201 may include similar functionality associated with the transaction module 204. In other embodiments, the workstations 201 may be different points at which the module 204 may be accessed. In the system 200, the transaction module 204 may be any suitable server, processor, computer, or data processing device, or combination of the same.

The computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links 202 and 205 may be any communications links suitable for communicating between the workstations 201 and the integrated transaction module 204, such as network links, dial-up links, wireless links, hard-wired links, etc.

The steps that follow in the Figures may be implemented by one or more of the components as illustrated in FIGS. 1 and 2 and/or other components, including other computing devices.

A transaction created in the integrated transaction module 101 may include various data (e.g., companies involved in the transaction, members of the transaction team, transaction attributes, type of transaction, comments, and its financial information.) Each type of information may be categorized and represented in individual sections, with each section being independently modifiable. Each transaction in the transaction module 101 may be linked with multiple external systems (e.g., an equity trading restriction system and/or a revenue tracking system). The transaction module 101 may maintain a real-time link with these systems to keep information between these systems synchronized. When a new transaction is created in integrated transaction system 101, a corresponding transaction with its associated identifier (ID) may automatically be created in external systems for generating information about various aspects of the transaction. In populating each of the fields with information about a transaction within the transaction module 101, the selection of specific information about a transaction may be via a dropdown menu, multi-select box, textbox, checkbox, search/select box, in built calendar, radio button, slider, and/or may be system generated or suggested, among other things. Some of the information may be optional while other pieces of information about a transaction may be mandatory. In addition, some pieces of information may only apply to specific types of transactions (e.g., mergers and acquisitions, etc.).

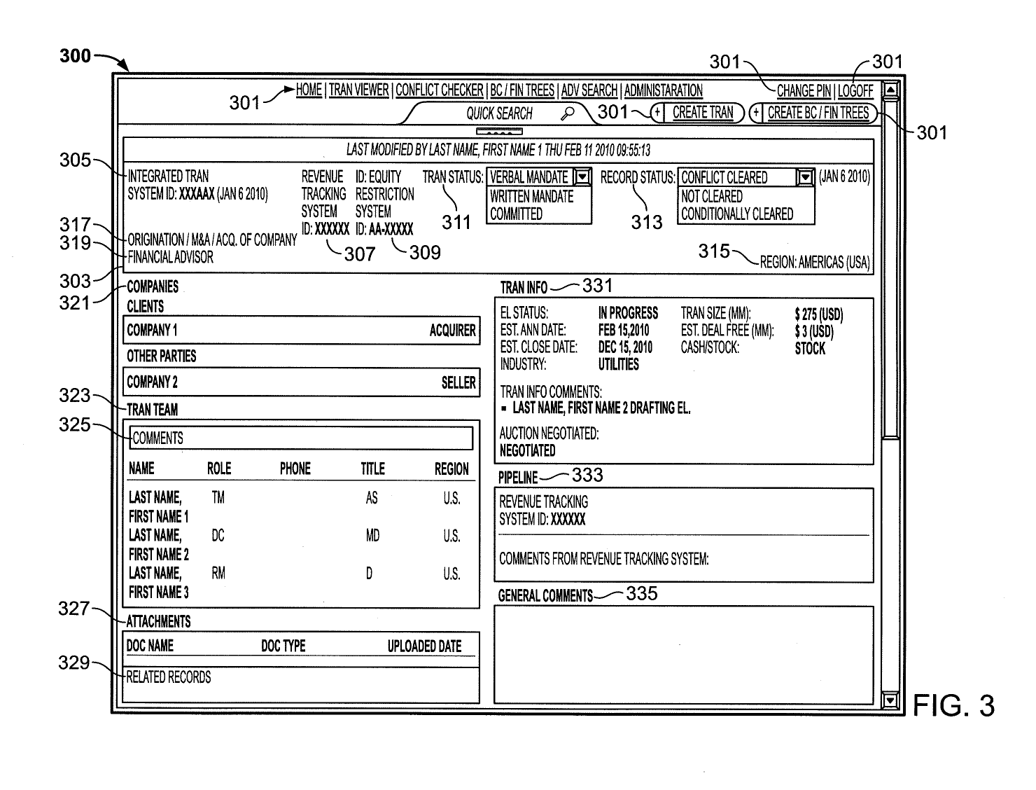

A sample transaction in a transaction viewer screen 300 of the integrated transaction module 101 is shown in FIG. 3. At the top of the transaction viewer screen 300 are quick links 301 to various other screens. When a user clicks on one of these quick links 301, the quick links 301 may transfer the user to screens such as: a home screen, a conflict checker screen, a best client (BC)/financial (FIN) trees screen, an advanced search screen, and/or an administration screen, described further below. In addition, the quick links 301 may be used for various functions, such as: to create a new transaction, create new best client (BC) and/or financial (FIN) tree scenario, change the personal identification number (PIN) for access to the integrated transaction system 101, and/or logoff the system 101. For example, if the quick link 301 for creating a new transaction is chosen, additional screens/windows that allow a user to enter all of the information shown in FIG. 3 may be displayed.

As illustrated in FIG. 3, the transaction viewer screen 300 may include a transaction header section 303 displaying the integrated transaction system ID 305 and various other IDs that correspond to the same transaction within other systems, including a revenue tracking system ID 307 and an equity restriction system ID 309. The revenue tracking system may be used to track the revenue potential or the revenue generated through the completion of a transaction and the equity restriction system may be used to place restrictions on trades of certain stocks/securities when confronted with a conflict of interest because of a transaction. It should be noted that any number of other systems may interface with the integrated transaction system 101, and each of these systems may be represented in a similar fashion such that the identifiers for a particular transaction in all systems may be displayed within the integrated transaction system 101.

In addition, the date (e.g. Jan. 6, 2010 as shown in FIG. 3 next to the integrated transaction system ID) that a transaction was created in the transaction module 101 may be shown on the transaction viewer screen 300. Additionally, a transaction status 311 may be displayed on the transaction view screen 300. The transaction status 311 may refer to the developmental stage of a particular transaction. Examples of developmental stages include “verbal mandate,” “written mandate,” and “committed,” as shown in FIG. 3, as well as “pitch,” “active,” “commence of marketing,” “completed,” “dead,” “postponed,” and “prospecting,” among others. These developmental stages may refer to the maturity or status of a transaction as it is initially pitched, prospected and marketed to a potential client. After a transaction is created, it may be in an active state. After a certain amount of time has passed, the transaction may be placed in a pitch or prospecting state, meaning that an entity such as a financial institution is marketing its capabilities for managing the transaction. When a transaction is placed in the pitch or prospecting state, a corresponding transaction identifier may optionally be created in the revenue tracking system. Potential clients may commit to the entity with vary levels of conviction. A verbal mandate may refer to a verbal commitment such as through a telephone call or a face-to-face meeting between representatives of an entity and its potential client. Meanwhile, a written mandate may point to a higher level of commitment by a potential client such as through the signing of a formal engagement letter and/or contract for work to be performed under certain terms (e.g., fees, duration of work, etc.). Over time, work under the terms of the written and/or verbal mandate may be completed or postponed. In other cases, the terms of any mandate received may be abrogated, thereby rendering the transaction “dead.” It should be noted that other transaction statutes 311 may be used to represent the various developmental stages for a particular transaction.

Another transaction attribute shown in the transaction viewer screen 300 may include the record status 313. The record status 313 may refer to whether or not the transaction has undergone a conflicts check. As mentioned earlier, a conflict-of-interest in representing a potential client may arise for a variety of reasons. In one scenario, the potential client may represent a party that is adverse to a current client of an organization; in other scenarios, a conflict-of-interest may arise from a strategic partnership that an organization deems more important than work represented by the potential new client. Examples of values for the record status 313 may include “pending,” “conditionally cleared,” “conflict cleared,” “not cleared,” and “not applicable.” If work representing a particular transaction has not finished a conflict-of-interest clearing process, the transaction may be marked in the record status 313 as “pending” or “not cleared.” If the transaction has completed some level of conflicts clearing, the transaction may be marked as “conditionally cleared” and/or “conflict cleared” in the record status 313, Finally, if the conflicts clearing process is not important for a particular transaction, the record status 313 for this transaction may assume a value of “not applicable” or “N/A.”

The transaction header 303 may also include a geographic region indicator 315 that applies to the location of a particular transaction, such as the Americas, Europe, Asia, Middle East, Africa, and/or the Pacific Rim. In addition, the geographic region indicator 315 may include a specific country that is specific to the transaction.

To further define the nature of a transaction, the transaction viewer screen 300 may include designations 317 that define a product category, product type, and a product name. The product category may refer to the broadest designation for a particular transaction. Example product categories include “origination,” “global markets,” and/or “principal investments.” A transaction may be classified under the origination category when the transaction involves a structural change in a company (e.g., selling part of a company, etc.) Principal investments may refer to a transaction that includes investment by an entity, such as in a client company or a sovereign fund. The global markets category may refer to transactions involving raising/issuing debt (e.g., in the form of bonds) by a company. Each product category may be further divided into product types, such as an equity-based or debt-based transaction within the origination category. Finally, each product type may also be further specified based on a product name such as an initial public offering (IPO) product name within the equity product type and origination category. Certain fields within the transaction viewer screen 300 may apply only to one or more of the product category, type, and name designations. It should be noted that any number of other classification schemes may be used to define the type of transaction. In the example of FIG. 3, the sample transaction is categorized in the origination category, mergers and acquisitions type, and acquisition of a company name.

Additionally, as illustrated in FIG. 3, the transaction viewer screen 300 may include a role 319, which may describe the role of the entity representing a potential client. For example, for the sample transaction shown in the transaction viewer screen 300, the role 319 is designated as “financial advisor.” Other possible categories for roles 319 may include “agent,” “arranger,” “co-advisor,” and/or “undefined,” among others. Different roles 319 may serve to indicate the scope of an entity's responsibilities in engaging a potential client. For instance, a “co-advisor” role may indicate that a potential client may have engaged two or more separate entities for performing work related to a particular transaction.

The transaction viewer screen 300 may also include a company section 321, wherein the company section 321 lists the companies involved in a particular transaction. Similar to the roles 319 identified for an entity representing a client, the different companies 321 may assume a variety of differing roles 319 in a particular transaction. For instance, in the sample transaction shown in FIG. 3, company ABC Corp. is an “acquirer” and company DEF Inc. is a “seller.” These designations may indicate that in this example transaction, ABC Corp. is buying DEF Inc. Of course, a particular transaction may involve many complex transactions that require sophisticated role designations for each company involved in the transaction. For instance, a company may be a borrower (of funds, for example), issuer (of equity, for example), a subsidiary of a company designated as a target (e.g., part of a company being sold), an affiliate of one of the main parties to a transaction, and/or a shareholder in a party to the transaction, among other designations. From the company section 321, companies may be listed on transaction viewer screen 300 with the (potential) client of an entity may be highlighted, underlined, colored differently, italicized, and/or bolded to distinguish it from other companies 321 listed on screen 300.

In addition, the transaction viewer screen 300 may include a transaction team section 323. The transaction team section 323 of transaction viewer screen 300 may detail the individuals within an entity that are involved in a particular transaction. The transaction team section 323 may also indicate the role, job title, and location of the individual in the transaction. For instance, in the sample transaction shown in FIG. 3, Jane Doe is a team member (TM) with job title “associate” (AS) located in the United States. John Smith is a transaction captain (DC) with job title managing director (MD) and David Brooks is a relationship manager (RM) with job title director (D), both of which are also located in the United States. As shown in FIG. 3, the transaction team section 323 may also include the phone number of the individuals involved in the transaction and a transaction team conflicts check comments section 325, further described below.

The transaction viewer screen 300 may also include an attachments section 327. The attachment section may function to attach various documents related to the transaction. The document name, document type (e.g., Microsoft™ Word), and a date that the document was uploaded to the integrated transaction module 101 may be included on the transaction viewer screen 300. Example documents that may be attached to a particular transaction in attachments section 327 of transaction viewer screen 300 include engagement letters, reviews of a transaction, and/or confidentiality agreements.

Additionally, the transaction viewer screen 300 may include a related records section 329. The related records section 329 may include other transactions that may be linked to a particular transaction. For instance, in the example shown in FIG. 3, where a company ABC Corp. is seeking to buy company DEF Inc., if ABC Corp. needs a loan from the entity to complete the transaction, this loan transaction may be listed as a separate record within the related records section 329.

The transaction viewer screen 300 may also include a transaction information section 331. The transaction information section 331 may detail various aspects of the transaction, including a status of the engagement letter (EL), an estimated transaction announcement date (EST. ANN DATE), an estimated transaction closing date (EST. CLOSE DATE), the industry that pertains to the transaction, the monetary value of the transaction (TRAN SIZE), the estimated transaction fee (EST. TRAN FEE), and whether the fee for managing the transaction will be paid in cash, stock, or both. For instance, the EL status in the sample transaction shown in FIG. 3 is indicated as “IN PROGRESS,” meaning that an engagement letter is still being obtained. The EL status may be indicated as YES or NO if the status of the engagement letter is conclusively known. The EST. ANN DATE (i.e., when the transaction becomes public) is indicated as Feb. 15, 2010, the EST. CLOSE DATE is indicated as Dec. 15, 2010, and the industry served in the transaction is indicated as UTILITIES. Other industries served by a transaction may include healthcare, real estate, and energy, among others.

Additionally, the transaction information section 331 may also include a comments section that has additional information about the transaction (e.g., team member drafting the EL, etc.) and whether the transaction may be an auction type transaction or a negotiated transaction. If the transaction is an auction type transaction, a bidding process may be used to determine which entity may be hired by a potential client. On the other hand, a negotiated transaction usually involves a predetermined number of entities that may serve a potential client. In addition, the transaction viewer screen 300 may indicate if a transaction is “hostile,” meaning that one of the parties to the transaction have enough leverage to move forward with a transaction in spite of resistance from other parties to the transaction. Also, the transaction viewer screen 300 may also indicate multiple divisions within the entity that may be engaged to complete the transaction process.

The transaction viewer screen 300 may also include a pipeline section 333. The pipeline section 333 in transaction viewer screen 300 may include a summary of all identifiers in other databases/systems that refer to the same transaction. For instance, as shown in FIG. 3, the revenue tracking system ID for this sample transaction is indicated; in addition, pipeline section 333 may include comments from each system that is referenced in the pipeline section 333. When updates to transactions are made in the transaction module 101, these updates may be automatically propagated to other systems that may reference the same transaction in alternative systems. In this way, information in all of the systems may be synchronized with one another. Finally, a general comments section 335 may also be included in the transaction viewer screen 300 to detail any additional comments that may need to be made about the transaction.

Once the transaction has undergone a conflicts check, the transaction may go through various internal committees for approval. These committees may use the integrated transaction module 101 to learn about the transaction and decide on approval. The status of this approval may also be indicated within the transaction viewer screen 300. The system may automatically send messages to appropriate committee members for approval and/or signature, at the appropriate time.

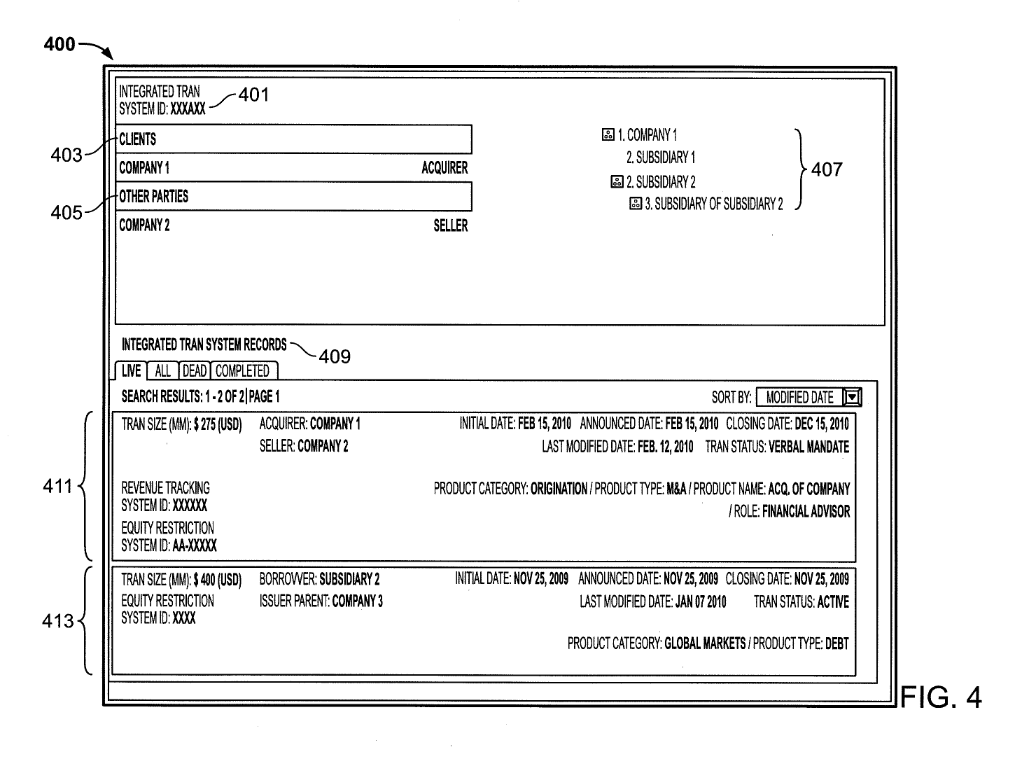

FIG. 4 shows an exemplary conflicts check screen 400 for the sample transaction shown in FIG. 3 in accordance with various aspects of the disclosure. The conflicts check screen 400 may include the integrated transaction system ID 401 for referencing the sample transaction. Also, the conflicts check screen 400 may include clients 403 and other parties 405. The clients 403 and their roles may be listed along with other parties 405 involved in the transaction. Because the sample conflicts check screen 400 shown in FIG. 4 corresponds to the transaction viewed in screen 300, ABC Corp. is again listed as an “acquirer” and DEF Inc. is again listed as a “seller.”

Along with this basic information, the conflicts check screen 400 may include a set of legal entity information 407 for companies that may be involved in a transaction. This legal entity information 407 may list the name of the companies including any affiliates and/or subsidiaries and may be provided in real-time from the financial markets through services such as Bloomberg™, which provides real-time market data and company news feeds. The legal entity information 407 obtained in real-time from these services may include name of the company, countries in which the company does business, acquisitions, stock price changes, financial status, last corporate filings, balance sheets, owner of the company, corporate structure, legal structure, etc. Different colors and/or fonts may be used to designate companies with which an entity managing integrated transaction system 101 may have done business in the past. The legal entity information 407 about subsidiaries of companies involved in a transaction may be shown for easy navigation and viewing by a user. Upon obtaining this legal entity information 407 in real-time from the financial markets, integrated transaction module 101 may then cross-check each of the companies and their subsidiaries against internal databases to determine if any of them have done/are doing/will be doing business with an entity.

Additionally, the conflicts check screen 400 may include a detailed records section 409. The detailed records section 409 may be generated by the cross-check with information about the clients 403 and/or the other parties 405 to a transaction, including positions, risk rating, market information, etc. The detailed records section 409 may also include the individual records 411 and 413 that may detail completed/dead/pending/current transactions that an entity may have managed with any clients that may be party to the sample transaction currently being analyzed for conflicts-of-interest.

For instance, in record 411, a brief overview of the transaction shown in FIG. 3 may be displayed. Record 411 may include information about the transaction size, corresponding identifiers in alternate systems with which the integrated transaction system interfaces, the name of the parties to the transaction and their roles, date that the transaction started (INITIAL DATE), date that the transaction was announced (ANNOUNCED DATE), date that the transaction will close (CLOSING DATE), last modified date, transaction status, product category, product type, product name, and role of the entity in managing the transaction. Record 411 represents details of the transaction that is currently being analyzed for conflicts-of-interest. Record 413 may include similar information about another transaction involving a subsidiary of one of the parties to the transaction currently being analyzed for conflicts-of-interest.

It should be noted that conflicts check screen 400 in the integrated transaction system 101 may or may not incorporate “hard-wired” rules to determine when a conflict-of-interest occurs. In many cases, a conflict-of-interest may be determined only by a user after thoroughly evaluating the information presented in the legal entity information 407 and/or the detailed records section 409. In other cases, some rules may be “hard-wired” into the conflicts check screen 400 so that red flags may be raised when working with a company represents a clear conflict-of-interest (e.g., company operates in terrorist countries, company has ties to known criminal organizations, etc.). In yet other cases, these checks may be made even before a potential client may be entered into the integrated transaction system 101.

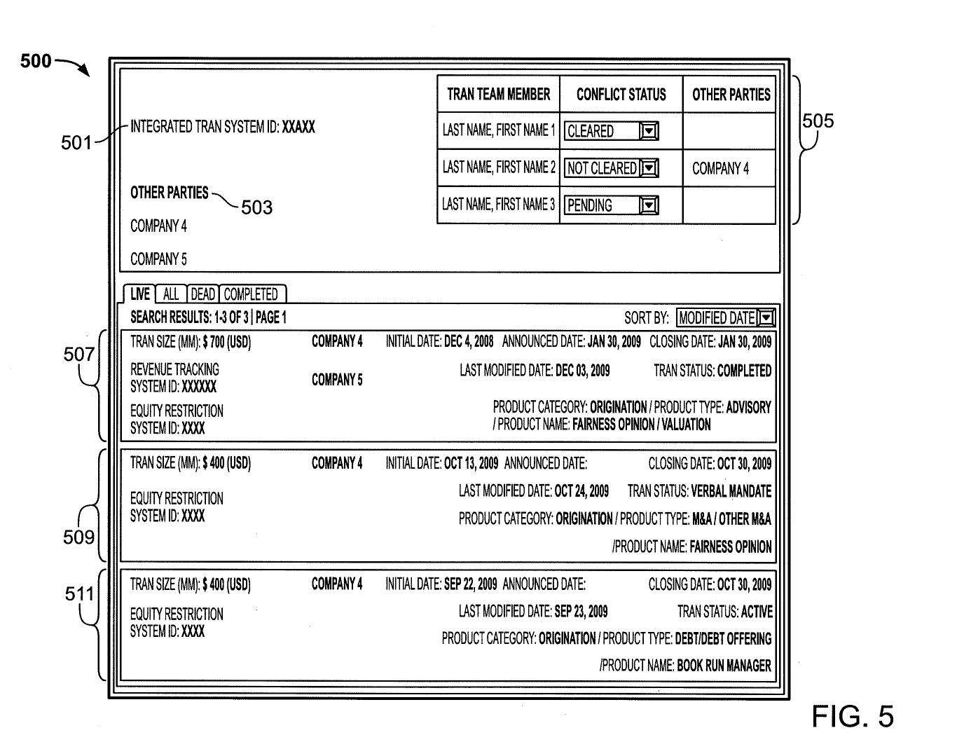

FIG. 5 shows a sample transaction team conflicts check screen 500 in the integrated transaction system 101 in accordance with various aspects of the disclosure. The transaction team conflicts check screen 500 may include information resulting from a conflicts-of-interest analysis for each member as listed in the transaction team section 323. As described above for the conflict check screen 400, the transaction team conflicts check screen 500 may include the integrated transaction system ID 501 for which the transaction team conflicts check is being performed. The transaction team conflicts check screen 500 may also include a parties section 503 that details the parties that may be involved in a transaction managed by an entity. In the sample case shown in FIG. 5, the parties to a transaction are listed as IJK Corp. and LMN Inc.

Additionally, the transaction team conflicts check screen 500 may include a conflict status section 505. The conflict status section 505 may summarize the results of a transaction team conflicts algorithm run in the integrated transaction system 101. As shown for the sample transaction in FIG. 5, the conflict status section 505 may show whether or not each transaction team member has cleared conflicts. A member of the transaction team may not have cleared conflicts for a variety of reasons; for instance, if the individual was/is previously or currently involved in representing a party adverse to a potential client in the sample transaction, the individual may not have the best interests of the potential client in mind in the sample transaction. Therefore, this individual would be marked as “NOT CLEARED” in the conflicts status section 505. Again, the algorithm/processor underlying the transaction team conflicts check screen 500 may or may not incorporate “hard-wired” rules for deciding on whether individuals of a transaction team have cleared conflicts. Rules such as the one described above for an individual that has represented parties adverse to a transaction may be used to highlight, underline, bold, or otherwise indicate that an individual may not have cleared conflicts. Prior to clearing conflicts, the individuals of the transaction team may be designated as “PENDING” or not designated by any conflicts status label.

In the example of FIG. 5, the three transaction team members are listed as Jane Doe, John Smith, and David Brooks. For this sample transaction, Jane Doe has cleared conflicts, John Smith has not cleared conflicts, and David Brooks is still being analyzed and, therefore, has a conflict status indicator of “PENDING.” The transaction team conflicts check screen 500 also indicates that John Smith has not cleared conflicts because of his previous/current involvement with one of the parties to the sample transaction, IJK Corp. Upon detecting such a conflict, a user must investigate the potential conflict-of-interest to determine whether or not the individual cannot be cleared of conflicts. If such a determination is made, this individual may be removed from the transaction team and/or replaced by another. On the other hand, a user may also determine that the previous involvement that the conflicts algorithm flagged may not have been substantial and/or relevant to warrant a conflict-of-interest, thus allowing the individual to continue to serve on the transaction team. Therefore, a user may “override” a conflict-of-interest flag raised by the transaction team conflicts checker and shown in the transaction team conflicts check screen 500.

The transaction team conflicts check screen 500 may also display individual records 507, 509, and 511 of transactions involving members of the current transaction team, for which a conflict of interest may be present. In both FIG. 4 and FIG. 5, a user may select the fields within individual records that may present a conflict-of-interest, thereby displaying more information related to that record. In general, throughout the various display screens of the transaction module 101, selecting the different fields/values shown may cause the display of additional information/windows related to the selected field/value.

The integrated transaction system 101 may also include an “audit trail” feature to capture all of the modifications to records within the system. The “audit trail” feature of the integrated transaction system 101 may keep track of who made a particular modification, when the modification was made, what the modification included, who looked at a particular transaction, etc.

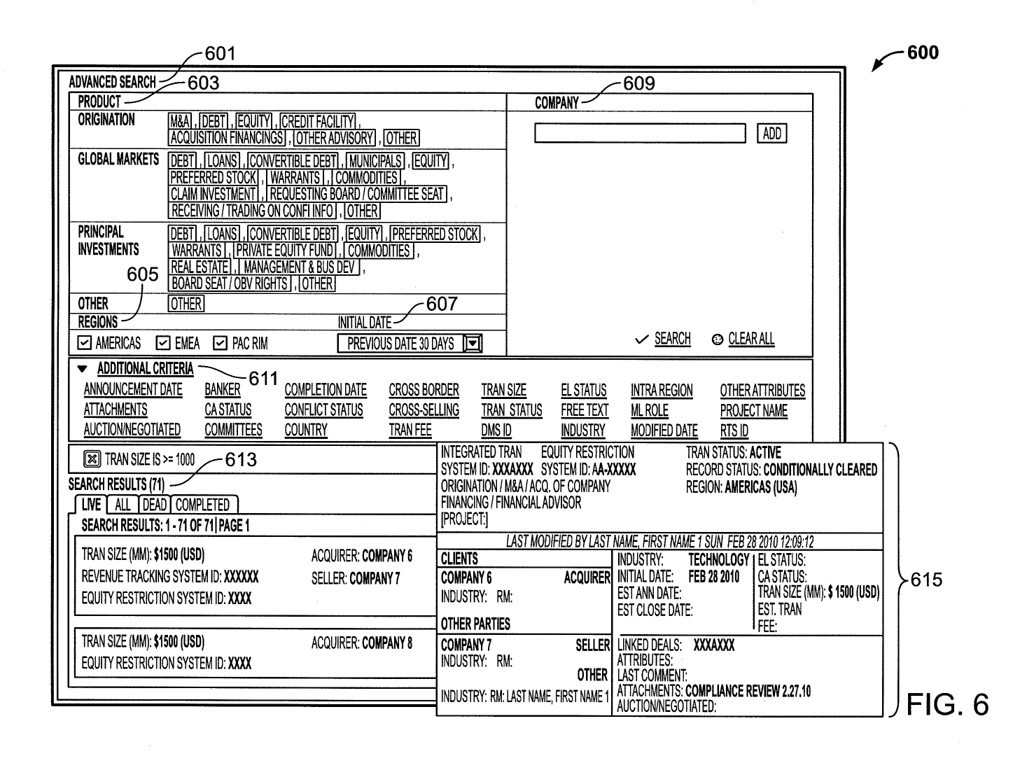

FIG. 6 shows a sample search screen 600 in accordance with various aspects of the disclosure. The search screen 600 may include an advanced search feature 601 that allows a user to search for transactions in the integrated transaction system 101 based on various product metrics 603. The products metrics 603 may include product category, product type, product name, geographical region 605 to which the transaction pertains, date created 607 (INITIAL DATE), etc. The search feature 601 also allows searches for transactions to be filtered based on the companies 609 involved in the transaction. The search screen 600 may also include additional search criteria 611. The additional search criteria 611 may narrow the number of transactions retrieved and may include the transaction announcement date, attachments added to the transaction in the transaction module 101, transaction completion date, and size of the transaction, among other things.

The sample search screen 600 may also include a search results section 613 from the search performed as described above. The search results section 613 of the search is based on the search criteria and may include various records similar to those shown in FIGS. 4 and 5. As before, clicking on one of the records in the search results section 613 may cause additional windows 615 to appear. These additional windows 615 may include more detailed information about the record. For instance, for the sample shown in FIG. 6, the additional window 615 includes the date that the transaction was created, the attachments to the transaction, transactions that are linked to the referenced transaction, etc.

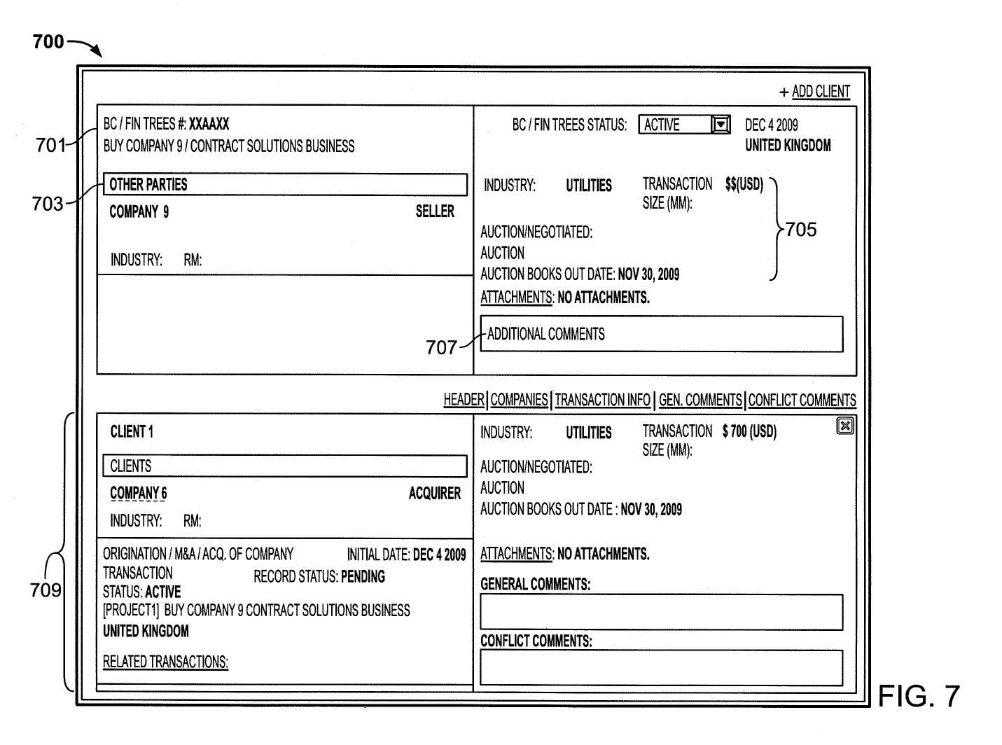

Additionally, as illustrated in FIG. 7, the integrated transaction system 101 may include a sample best client (BC)/financial (FIN) tree screen 700 in accordance with various aspects of the disclosure. Best client may refer to a potential client that offers the maximum benefit to an entity; for instance, a potential “best client” may be one that may pay the highest transaction fee, provides the longest term contract, is geographically located in a strategic position, and/or provides some other intangible benefit (e.g., fulfilling an charitable objective, promoting for the betterment of mankind, etc.) The algorithm/processing underlying the generation of the best client/financial tree screen 700 may aid an entity in selecting potential clients from a pool of clients as part of a transaction. The best client/financial tree screen 700 may include a best client/financial tree record number 701 and parties 703 to a potential transaction. Additionally, the best client/financial tree screen 700 may include a transaction type section 705. The transaction type section 705 may include additional details about the transaction, including whether or not it is an auction and/or negotiated transaction, additional attachments, and comments 707.

The best client/financial tree screen 700 may also include a best client section 709. The best client section 709 may include information related to various potential clients that may be interested in the transaction. For instance, in the example shown in FIG. 7, the first potential client is MNO Ltd. As illustrated in FIG. 7, the best client section 709 indicates that MNO Ltd. may be interested in a transaction involving buying XYZ Corp. Similarly, other potential clients may be listed in the best client section 709 to allow all potential clients to be evaluated in one place. Ultimately, the decision of which potential client an entity selects in a sample transaction may depend on a variety of factors, including the bid price, the relationship of the potential client with the entity, etc.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the screens illustrated in the illustrative figures and their underlying algorithms may be accessed in other than the presented order, and that one or more screens/algorithms illustrated may be optionally accessed in accordance with aspects of the invention.

What is claimed is:

1. A computer-assisted method comprising:
(i) receiving a selection for creating a new transaction;
(ii) using a processor of a computer, creating the new transaction involving a plurality of entities and a plurality of team members, wherein the new transaction is assigned a transaction identifier;
(iii) storing the new transaction into a nonvolatile memory of the computer;
(iv) using the processor of the computer, determining whether any of the plurality of entities is a first conflict-of-interest by analyzing a relationship with the plurality of entities; and
(v) using the processor of the computer, determining whether any of the plurality of team members is a second conflict-of-interest by analyzing involvement of the plurality of team members with the plurality of entities.

2. The computer-assisted method of claim 1, further comprising: linking the new transaction to a transaction in other systems.

3. The computer-assisted method of claim 1, further comprising: using the processor of the computer, determining which one of the plurality of entities is a best client by running a best client analysis and comparing a transaction fee offered by each of the plurality of entities.

4. The computer-assisted method of claim 1, further comprising: displaying the new transaction on a display of the computer, the display including a transaction header section, a companies section, a transaction team section, an attachments section, a transaction information section, a pipeline section, and a general comments section.

5. The computer-assisted method of claim 4, wherein the transaction header section comprises a transaction identifier, a plurality of corresponding identifiers of the new transaction in other systems, a transaction status, a record status, a job role, and a geographic region that corresponds to the new transaction.

6. The computer-assisted method of claim 5, wherein the transaction status is chosen from the group consisting of: verbal mandate, written mandate, committed, pitch, active, commence of marketing, completed, dead, postponed, and prospecting.

7. The computer-assisted method of claim 5, wherein the record status is chosen from the group consisting of: pending, conditionally cleared, conflict cleared, not cleared, and not applicable.

8. The computer-assisted method of claim 5, wherein the job role is chosen from the group consisting of: financial advisor, agent, arranger, co-advisor, and undefined.

9. The computer-assisted method of claim 4, wherein the transaction information section comprises an engagement letter status, a transaction announcement date, a transaction close date, a transaction size, and a transaction fee.

10. The computer-assisted method of claim 4, wherein the pipeline section comprises links to the new transaction referenced in additional systems.

11. The computer-assisted method of claim 1, further comprising: displaying information related to both the plurality of entities and subsidiaries of the plurality of entities.

12. The computer-assisted method of claim 11, wherein the information related to the plurality of entities and subsidiaries of the plurality of entities is received in real-time from a news feed provider.

13. The computer-assisted method of claim 12, wherein the information comprises a name of the plurality of entities, countries in which the plurality of entities does business, acquisitions by the plurality of entities, stock price changes for each of the plurality of entities, financial status of the plurality of entities, corporate filings of the plurality of entities, balance sheets of the plurality of entities, owner of each of the plurality of entities, corporate structure of the plurality of entities, and legal structure of the plurality of entities.

14. The method of claim 1, further comprising: displaying a name of each of the plurality of team members along with a designation of whether or not each of the plurality of team members has cleared conflicts.

15. An apparatus comprising:
a user interface configured to receive user inputs about a plurality of transactions within a computer system, wherein each of the plurality of transactions includes a plurality of team members and a plurality of entities;
a communication module configured to communicate transaction information with other computer systems; and
a processor configured to create new transactions, run a conflicts checker algorithm, run a transaction team conflicts algorithm, and run a best client algorithm.

16. The apparatus of claim 15, wherein the conflicts checker algorithm checks for conflicts-of-interest to determine whether one or more of the plurality of entities is a conflict-of-interest by analyzing a relationship with the plurality of entities.

17. The apparatus of claim 15, wherein the transaction team conflicts algorithm determines whether one or more of the plurality of team members is a conflict-of-interest by analyzing involvement of the plurality of team members with the plurality of entities.

18. The apparatus of claim 15, wherein the transaction team conflicts algorithm comprises predetermined rules for red flagging the plurality of team members when a conflict-of-interest is discovered.

19. The apparatus of claim 15, wherein the best client algorithm is used to determine which one of the plurality of entities is a best client in terms of a transaction fee associated with each of the plurality of clients and upon consideration of a strategic relationship with the plurality of entities.

20. A computer-readable storage medium having computer-executable program instructions stored thereon that when executed by a processor, cause the processor to perform steps comprising:
(i) receiving a selection for creating a new transaction;
(ii) creating the new transaction involving a plurality of entities and a plurality of team members, wherein the new transaction is assigned a transaction identifier;
(iii) running a conflict-of-interest check to determine whether one or more of the plurality of entities is a first conflict-of-interest by analyzing a relationship with the plurality of entities; and
(iv) running a transaction team conflict-of-interest check to determine whether one or more of the plurality of team members is a second conflict-of-interest analyzing involvement of the plurality of team members with the plurality of entities.
